(19) United States
(12) Patent Application Publication
(10) Pub. No.: US 2007/0064173 A1
(43) Pub. Date: Mar. 22, 2007

(54) Double-Sided Liquid Crystal Display

(75) Inventors: Chun-Yi Chiu, Taoyuan City, Taoyuan County (TW); Min-Chieh Hu, Shanhua Town, Tainan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORPORATION, Hsin-Chu (TW)

(21) Appl. No.: 11/456,250

(22) Filed: Jul. 10, 2006

(30) Foreign Application Priority Data
Sep. 20, 2005 (TW) 94132502

(51) Int. Cl. G02F 1/1335

(52) U.S. Cl. 349/69

(57) ABSTRACT

A double-sided liquid crystal display (LCD) capable of displaying double frames on both faces thereof is provided. The backlight of the double-sided LCD is a module of organic light-emitting diodes (OLEDs). The module of OLEDs is composed of multiple top-emission OLEDs and multiple bottom-emission OLEDs. The top-emission OLEDs and the bottom-emission OLEDs are alternatively arranged in the module of OLEDs.

### RELATED APPLICATIONS

The present application is based on, and claims priority from, Taiwan Patent Application Serial Number 94132502, filed Sep. 20, 2005, the disclosure of which is hereby incorporated by reference herein in its entirety.

### BACKGROUND OF THE INVENTION

1. Field of Invention

The present invention relates to a liquid crystal display. More particularly, the present invention relates to a double-sided liquid crystal display.

2. Description of Related Art

Since the functions of mobile electronic products diversify, a need for double-sided liquid crystal display (LCD) is getting increased. A double-sided LCD is generally made by assembling two LCDs back-to-back and then integrated into a mobile electronic product. However, this kind of LCDs is thick and heavy, and the light and handy properties of mobile electronic products are sacrificed.

Organic light-emitting diodes (OLEDs) have become the main stream of the next generation flat panel displayer's luminescence devices because of important features such as self-luminescence, fast response, low driving voltage, wide viewing angle, thin film thickness, simple process and low cost. Hence, OLEDs have been the main stream of light-emitting devices of flat panel displays. Some disclosed processes, such as TW 583466, have used OLEDs to replace cold cathode fluorescent tube to be back light of a LCD; the weight of the LCD is thus reduced. However, a double-sided LCD still requires two OLED back light modules to be assembled back-to-back.

### SUMMARY OF THE INVENTION

In one aspect, the present invention provides a double-sided LCD using only one OLED back light module for reducing the thickness and weight of the double-sided LCD to be used in mobile electronic devices.

According to a preferred embodiment of the present invention, a double-sided backlight module can be formed by alternatively arranging top-emission OLEDs and bottom-emission OLEDs on a transparent substrate. Then, this double-sided backlight module can be sandwiched by two LCD panels to form a double-sided LCD.

Accordingly, although only one backlight module is used for a double-sided LCD, light can be emitted from both faces of the backlight module. Hence, the thickness and the weight of a double-sided LCD can be further reduced to maintain the light and handy features of a mobile electronic product.

It is to be understood that both the foregoing general description and the following detailed description are made by use of examples and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 is a cross-sectional diagram showing an organic luminescent module according a preferred embodiment of this invention; and

FIG. 2 is cross-sectional diagram showing a double-sided LCD according to a preferred embodiment of this invention.

### DESCRIPTION OF THE PREFERRED EMBODIMENTS

Reference will now be made in detail to the present preferred embodiments of the invention, examples of which are illustrated in the accompanying drawings.

An OLED is formed by stacking multiple thin films, which includes a transparent anode, an organic luminescent layer, a metal cathode. The organic luminescent layer can be further subdivided into a hole injection layer (HIL), a hole transfer layer (HTL), an emission layer (EML), an electron transfer layer (ETL), and an electron injection layer (EIL), wherein the HIL is connected to the transparent anode and the EIL is connected to the metal cathode.

The luminescent principle of OLEDs is described below. Holes injected from the transparent anode and electrons injected from the metal anode are combined at the emission layer to enable molecules in the emission layer to be excited. After excited molecules go back to the ground state, the energy is thus released in the form of light.

Since the thickness of the metal cathode is at least 1500 Å, the metal cathode is not pervious to light. Therefore, a conventional double-sided LCD requires two backlight modules to display frames on both faces of the double-sided LCD.

In light of foregoing, this invention provides a double-sided LCD having only one backlight module made by multiple OLEDs. According to a preferred embodiment of this invention, multiple top-emission OLEDs and bottom-emission OLEDs are alternatively formed on a transparent substrate by lithography and etching processes. Hence, although only one organic luminescent module is made, light can be emitted from both faces of the organic luminescent module. The thickness and weight of the double-sided LCD can be further reduced to maintain the light and handy features of mobile electronic products.

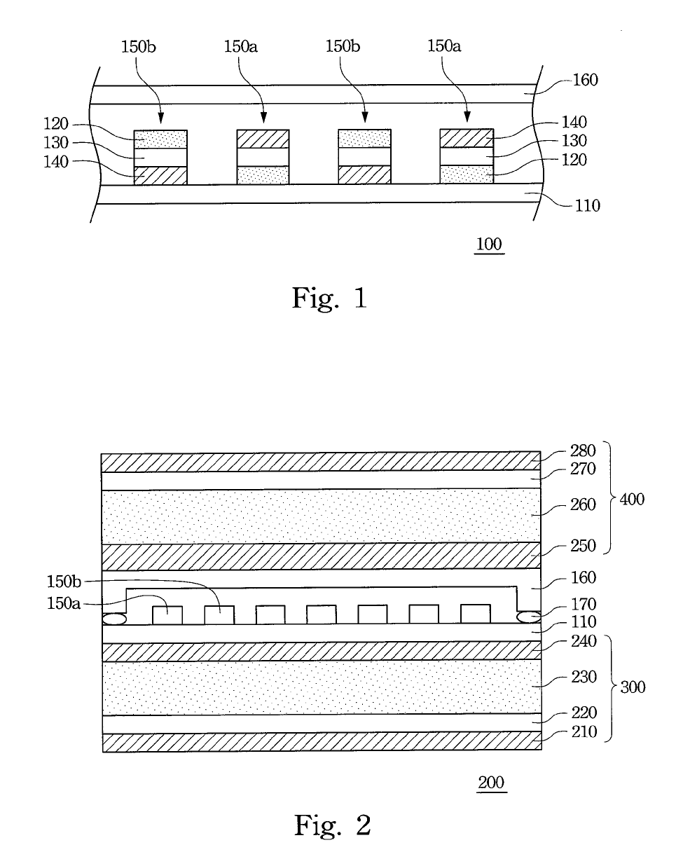

FIG. 1 is a cross-sectional diagram showing an organic luminescent module according a preferred embodiment of this invention. In FIG. 1, multiple top-emission OLEDs 150a and bottom-emission OLEDs 150b are alternatively arranged on a transparent substrate 110, and another transparent substrate 160 covers the top-emission OLEDs 150a and bottom-emission OLEDs 150b. A glue 170 (shown in FIG. 2) is used to seal the edges of the transparent substrates 110 and 160 to form an organic luminescent module 100 capable of emitting light from both faces thereof.

The material layers, from bottom to top, of the top-emission OLEDs 150a are sequentially a metal cathode 120, an organic emission layer 130 and a transparent anode 140. The material layers, from bottom to top, of the bottom-emission OLEDs 150a are sequentially a transparent anode 140, an organic emission layer 130 and a metal cathode 120. The material of the organic emission layer 130 is, for example, an organic emission material or a polymer emission material.

The manufacturing method of the top-emission OLEDs 150a and the bottom-emission OLEDs 150b can be any conventional known methods. Since person skilled in the art can easily decide which method is suitable for producing the top-emission OLEDs 150a and the bottom-emission OLEDs 150b, the fabrication methods are omitted here.

FIG. 2 is cross-sectional diagram showing a double-sided LCD according to a preferred embodiment of this invention. In FIG. 2, two LCD panels are respectively formed on the transparent substrate 110 and 160 of the organic luminescent module 100 to form a double-sided LCD 200 capable of showing frames on both faces. The layers below the transparent substrate 110 forming a first LCD panel are sequentially a control substrate 240, a liquid crystal layer 230, a common electrode 220 and a transparent substrate 210. The layers below the transparent substrate 110. The layers above the transparent substrate 160 forming a second LCD panel are sequentially a control substrate 250, a liquid crystal layer 260, a common electrode 270 and a transparent substrate 280.

A color filter layer (not shown in FIG. 2) of the first LCD panel can be located on the control substrate 240 or the transparent substrate 210. Similarly, a color filter layer (not shown in FIG. 2) of the first LCD panel can be located on the control substrate 250 or the transparent substrate 280. Since persons skilled in the art know how to manufacture many kinds of LCD panels very well, the manufacture methods of the first and the second LCD panels are omitted here.

As embodied by the preferred embodiments described above, the top-emission OLEDs and the bottom-emission OLEDs arranged alternatively can form an organic luminescent module capable of emitting light from both faces. The organic luminescent module capable of emitting light from both faces can be a backlight module to be sandwiched in two LCD panels to form a double-sided LCD capable of showing frames on both faces. Therefore, the thickness and weight of a double-sided LCD can be reduced to be accommodated in mobile electronic products more suitably.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A double-sided liquid crystal display (LCD), comprising:
a first LCD module;
an organic luminescent module disposed on the first LCD module, the organic luminescent module having plural top-emission organic light-emitting diodes (OLEDs) and plural bottom-emission OLEDs; and
a second LCD module disposed on the organic luminescent module.

2. The double-sided LCD of claim 1, further comprising:
a first transparent substrate located between the first LCD module and the organic luminescent module; and
a second transparent substrate located between the organic luminescent module and the second LCD module.

3. The double-sided LCD of claim 2, wherein each of the top-emission OLEDs comprises:
a metal cathode located on the first transparent substrate;
an organic emission layer located on the metal cathode; and
a transparent anode located on the organic emission layer.

4. The double-sided LCD of claim 3, wherein the organic emission layer includes organic or polymer material.

5. The double-sided LCD of claim 2, wherein each of the bottom-emission OLEDs comprises:
a transparent anode located on the first transparent substrate;
an organic emission layer located on the transparent anode; and
a metal cathode located on the organic emission layer.

6. The double-sided LCD of claim 5, wherein the organic emission layer comprises organic or polymer material.

7. A double-sided liquid crystal display (LCD), comprising:
a first transparent substrate;
a first common electrode on the first transparent substrate;
a first liquid crystal layer on the common electrode;
a first control substrate on the liquid crystal layer, the first control substrate having a first control circuit and a first pixel electrode array;
a second transparent substrate located on the first control substrate;
an organic luminescent module on the second transparent substrate, the organic luminescent module having plural top-emission organic light-emitting diodes (OLEDs) and plural bottom-emission OLEDs
a third transparent substrate on the organic luminescent module;
a second control substrate on the third transparent substrate, the second control substrate having a second control circuit and a second pixel electrode array;
a second liquid crystal layer on the second control substrate;
a second common electrode on the second liquid crystal layer; and
a fourth transparent substrate on the second common electrode.

8. The double-sided LCD of claim 7, wherein each of the top-emission OLED comprises:
a metal cathode located on the second transparent substrate;
an organic emission layer located on the metal cathode; and
a transparent anode located on the organic emission layer.

9. The double-sided LCD of claim 8, wherein the organic emission layer comprises organic or polymer material.

10. The double-sided LCD of claim 7, wherein each of the bottom-emission OLED comprises:
a transparent anode located on the second transparent substrate;
an organic emission layer located on the transparent anode; and
a metal cathode located on the organic emission layer.

11. The double-sided LCD of claim 10, wherein the organic emission layer comprises organic or polymer material.

12. The double-sided LCD of claim 7, wherein at least one of the first and the fourth transparent substrates has a color filter layer.

13. The double-sided LCD of claim 7, wherein at least one of the first and the second control substrates has a color filter layer.
